(19) United States
(12) Patent Application Publication
(10) Pub. No.: US 2026/0169781 A1
(43) Pub. Date: Jun. 18, 2026

(54) Dirty Data Tracking for Live Migration of Virtual Machines

(71) Applicants: Advanced Micro Devices, Inc, Santa Clara, CA (US); ATI Technologies ULC, Markham (CA)

(72) Inventors: Shivam Swami, Ottawa (CA); Nuwan S. Jayasena, Cupertino, CA (US)

(73) Assignees: Advanced Micro Devices, Inc, Santa Clara, CA (US); ATI Technologies ULC, Markham (CA)

(21) Appl. No.: 18/982,928

(22) Filed: Dec. 16, 2024

(51) Int. Cl. G06F 9/455; G06F 21/60

(52) U.S. Cl. CPC G06F 9/45558; G06F 21/602; G06F 21/604; G06F 2009/4557; G06F 2009/45583

(57) ABSTRACT

In accordance with the described techniques, a system includes a destination server and a source server configured to migrate a virtual machine running on the source server to the destination server over multiple migration iterations. As part of this, the source server generates first hashes of memory blocks of a memory page allocated to the virtual machine during a first migration iteration of the multiple migration iterations. In addition, the source server generates second hashes of the memory blocks during a second migration iteration of the multiple migration iterations. During the second migration iteration, the source server transfers one or more dirty memory blocks of the memory page that have been modified on the source server since the first migration iteration based on a comparison of the first hashes and the second hashes.

### BACKGROUND

Virtual machines are software emulations of physical computers that each run an operating system (e.g., a guest operating system) in an isolated execution environment. Virtual machines, therefore, allow multiple operating systems to run on a single physical machine, which improves flexibility, scalability, and resource utilization for data centers and large scale deployments. Live migration is a process that enables a virtual machine to be moved from one physical machine to another physical machine with minimal service disruption. Live migration is crucial for efficient operation of data centers and cloud computing environments. For example, live migration ensures that service level agreements (SLAs) associated with a virtual machine continue to be met while the virtual machine is moved from a first physical machine to a second physical machine for purposes of load balancing, performing maintenance and/or platform upgrades on the first physical machine, and the like

### BRIEF DESCRIPTION OF THE DRAWINGS

FIG. 1 is a block diagram of a processing system configured to execute one or more applications, in accordance with one or more implementations.

FIG. 2 is a block diagram of a non-limiting example system to implement dirty data tracking for live migration of virtual machines.

FIG. 3 depicts an example of a source server transferring a memory page allocated to a virtual machine to a destination server during a first migration iteration of a live migration process for the virtual machine.

FIG. 4 depicts an example of the source server transferring the memory page allocated to the virtual machine to a destination server during a subsequent migration iteration of the live migration process for the virtual machine.

FIG. 5 depicts an example of a destination server receiving the memory page allocated to the virtual machine during the subsequent migration iteration of the live migration process for the virtual machine.

FIG. 6 depicts an example of generating hashes of memory blocks in accordance with one or more implementations.

FIG. 7 depicts an example of generating combined hashes of memory blocks in accordance with one or more implementations.

FIG. 8 depicts a procedure in an example implementation of dirty data tracking for live migration of virtual machines

### DETAILED DESCRIPTION

### Overview

In accordance with the described techniques, a data center includes a plurality of servers. In particular, the data center includes a source server running a virtual machine, and the source server is configured to migrate the virtual machine to a destination server of the data center using live migration techniques. As part of running the virtual machine, the source server includes a portion of memory allocated to the virtual machine, e.g., virtual machine (VM) allocated memory. In accordance with live migration, the virtual machine continues to run on the source server while the VM allocated memory is copied to the destination server over a plurality of migration iterations.

One conventional live migration technique is pre-copy live migration. In each migration iteration of this conventional technique, only the memory pages that were modified since the previous migration iteration (e.g., the memory pages containing dirty data) are transferred to the destination server. Generally, the number of memory pages to be copied to the destination server is reduced as the live migration process progresses. During a final migration iteration, the virtual machine is briefly paused while the remaining memory pages are copied to the destination server, e.g., a blackout period. However, pre-copy live migration tracks dirty data of the VM allocated memory at memory-page-level granularity, and as such, an entire memory page is transferred to the destination server when the memory page is detected as having been modified since a previous migration iteration. Thus, pre-copy live migration incurs excess network bandwidth consumption and power consumption in each migration iteration by transferring entire memory pages when just portions of the memory pages are dirty. Furthermore, pre-copy live migration inflates downtime of the virtual machine during the blackout period in scenarios in which a relatively small amount of dirty data is spread across multiple memory pages.

Accordingly, the described techniques track dirty data in the VM allocated memory at a finer granularity, and therefore, transfer less data than conventional techniques in each migration iteration. In accordance with the described techniques, each memory page of the VM allocated memory is partitioned into fixed-length units of memory, referred to as memory blocks. During a first migration iteration, the source server is configured to encrypt each memory block of each memory page of the VM allocated memory for transportation to the destination server using an authenticated encryption function. In one or more implementations, the authenticated encryption function is a modified version of the Advanced Encryption Standard – Galois/Counter Mode (AES-GCM). Generally, the modified AES-GCM protocol encrypts the data of each memory block, and generates hashes of the encrypted data using a hashing function. A hash of a memory block of a memory page generated in accordance with the modified AES-GCM protocol is independent of the data contained in other memory blocks of the memory page. This contrasts with conventional AES-GCM which generates hashes of the memory blocks sequentially, such that the hash of a respective memory block is dependent on the data of each previous memory block in the sequence. During the first migration iteration, therefore, the source server generates a first hash and encrypted data for each memory block of each memory page of the VM allocated memory. In addition, the source server stores the first hashes in memory, and transfers the encrypted data of the VM allocated memory to the destination server.

When a subsequent migration iteration is initiated, the source server identifies the dirty memory pages that have been modified since the first migration iteration, e.g., using a data structure that tracks dirty memory pages, such as a page table. During the subsequent migration iteration, the source server encrypts each memory block of each dirty memory page using the authenticated encryption function, e.g., the modified AES-GCM protocol. In doing so, the source server generates encrypted data and second hashes of the memory blocks of the dirty memory pages, and compares the second hashes to the first hashes stored in memory. If the first hash of a memory block differs from the second hash of the memory block, the memory block is identified as a dirty memory block. Thus, during the subsequent migration iteration, the source server transfers the encrypted data of the dirty memory blocks of the identified dirty memory pages to the destination server, but refrains from transferring clean memory pages and clean memory blocks of dirty memory pages. This process is repeated over a plurality of migration iterations with the source server transferring, in each migration iteration, only the dirty memory blocks that have been modified since the previous migration iteration.

Accordingly, the described techniques reduce network bandwidth and power consumption as compared to conventional techniques. This is because, in each subsequent migration iteration, the described techniques transfer solely the dirty memory blocks rather than the dirty memory pages in their entirety including clean memory blocks. This also reduces virtual machine downtime in the blackout period because less data is transferred during the final migration iteration. Moreover, the described techniques improve runtime performance of the virtual machine by tracking the dirty memory blocks using the hashes (e.g., as opposed to using a page table), thereby alleviating the virtual machine from marking memory blocks as dirty whenever the virtual machine writes data to the VM allocated memory during the live migration process.

In some aspects, the techniques described herein relate to a system, comprising a destination server, and a source server configured to migrate a virtual machine running on the source server to the destination server over multiple migration iterations by performing operations including generating, during a first migration iteration of the multiple migration iterations, first hashes of memory blocks of a memory page allocated to the virtual machine, generating, during a second migration iteration of the multiple migration iterations, second hashes of the memory blocks of the memory page, and transferring, during the second migration iteration, one or more dirty memory blocks of the memory page to the destination server that have been modified on the source server since the first migration iteration based on a comparison of the first hashes and the second hashes.

In some aspects, the techniques described herein relate to a system, wherein the one or more dirty memory blocks are each associated with a respective first hash of the first hashes and a respective second hash of the second hashes, and wherein the respective first hash and the respective second hash are different.

In some aspects, the techniques described herein relate to a system, the operations further including generating, during the multiple migration iterations, encrypted data of the memory blocks.

In some aspects, the techniques described herein relate to a system, wherein generating the first hashes includes generating the first hashes of the encrypted data of the memory blocks during the first migration iteration, and generating the second hashes includes generating the second hashes of the encrypted data of the memory blocks during the second migration iteration, and transferring the one or more dirty memory blocks includes transferring the encrypted data of the one or more dirty memory blocks.

In some aspects, the techniques described herein relate to a system, wherein generating the encrypted data includes providing memory addresses of the memory blocks as input to an authenticated encryption function.

In some aspects, the techniques described herein relate to a system, wherein generating the encrypted data includes providing counter values of the memory blocks as input to an authenticated encryption function, a counter value of a respective memory block representing a number of times the respective memory block has been modified on the source server over consecutive migration iterations of the multiple migration iterations.

In some aspects, the techniques described herein relate to a system, the operations further including storing, during the first migration iteration, the first hashes and the counter values in memory of the source server, generating, during the second migration iteration, the second hashes using the counter values stored in the memory, and detecting, during the second migration iteration, the one or more dirty memory blocks based on the comparison of the first hashes stored in the memory to the second hashes.

In some aspects, the techniques described herein relate to a system, the operations further including incrementing, during the second migration iteration, one or more of the counter values of the one or more dirty memory blocks responsive to detecting the one or more dirty memory blocks, regenerating, during the second migration iteration, one or more hashes of the one or more dirty memory blocks using the one or more incremented counter values, storing, during the second migration iteration, the one or more incremented counter values in the memory, and replacing, during the second migration iteration, one or more of the first hashes of the one or more dirty memory blocks with the one or more regenerated hashes in the memory.

In some aspects, the techniques described herein relate to a system, the operations further including generating, during the second migration iteration, an authentication tag by combining the one or more regenerated hashes of the one or more dirty memory blocks using a secure hash combination function, and communicating, during the second migration iteration, the authentication tag to the destination server.

In some aspects, the techniques described herein relate to a system, the operations further including generating, during the second migration iteration, a vector that identifies the one or more dirty memory blocks, and communicating, during the second migration iteration, the vector to the destination server.

In some aspects, the techniques described herein relate to a system, wherein generating the first hashes and the second hashes includes generating, during the multiple migration iterations, combined hashes of the memory blocks, a combined hash of a respective memory block representing a combination of additional hashes of multiple memory chunks within the respective memory block.

In some aspects, the techniques described herein relate to a system, wherein the first hashes are the combined hashes of the memory blocks generated during the first migration iteration, and the second hashes are the combined hashes of the memory blocks generated during the second migration iteration.

In some aspects, the techniques described herein relate to a system, comprising a source server running a virtual machine, and a destination server to receive a memory page of the virtual machine partitioned into memory blocks as part of a migration process to migrate the virtual machine to the destination server by performing operations including receiving, during a second migration iteration, one or more dirty memory blocks of the memory page that have been modified on the source server since a first migration iteration, the one or more dirty memory blocks detected based on a comparison of first hashes of the memory blocks generated during the first migration iteration to second hashes of the memory blocks generated during the second migration iteration.

In some aspects, the techniques described herein relate to a system, the operations further including storing, in memory of the destination server, counter values of the memory blocks, a counter value of a respective memory block representing a number of times the respective memory block has been modified over consecutive migration iterations.

In some aspects, the techniques described herein relate to a system, wherein receiving the one or more dirty memory blocks includes receiving encrypted data of the one or more dirty memory blocks having been encrypted using an authenticated encryption function, the operations further including incrementing one or more of the counter values associated with the one or more dirty memory blocks, receiving one or more memory addresses of the one or more dirty memory blocks and an authentication tag representing a first combination of one or more hashes of the one or more dirty memory blocks, generating, using the authenticated encryption function, a validation tag based on the encrypted data, the one or more memory addresses, and the one or more incremented counter values, and accepting the one or more dirty memory blocks into the memory based on the validation tag matching the authentication tag.

In some aspects, the techniques described herein relate to a system, wherein incrementing the one or more counter values includes receiving a vector that identifies the one or more dirty memory blocks, and incrementing the one or more counter values based on the vector.

In some aspects, the techniques described herein relate to a system, the operations further comprising decrypting the encrypted data of the one or more dirty memory blocks, in part, by computing, before receiving the one or more dirty memory blocks, one or more one-time pads for the one or more dirty memory blocks based on the vector and the one or more incremented counter values.

In some aspects, the techniques described herein relate to a source server, configured to migrate a memory page of a virtual machine to a destination server by performing operations including generating, during a first migration iteration, a first combined hash of a memory block of the memory page by combining first hashes of multiple memory chunks within the memory block, generating, during a second migration iteration, a second combined hash of the memory block by combining second hashes of the multiple memory chunks within the memory block, and transferring, during the second migration iteration, the memory block to the destination server based on the first combined hash and the second combined hash being different.

In some aspects, the techniques described herein relate to a source server, wherein the memory block is not transferred to the destination server during the second migration iteration based on the first combined hash equaling the second combined hash.

In some aspects, the techniques described herein relate to a source server, the operations further comprising storing a counter value of the memory block in memory of the source server, the counter value representing a number of times the memory block has been modified on the source server over consecutive migration iterations, and wherein the first combined hash and the second combined hash are generated based on the counter value.

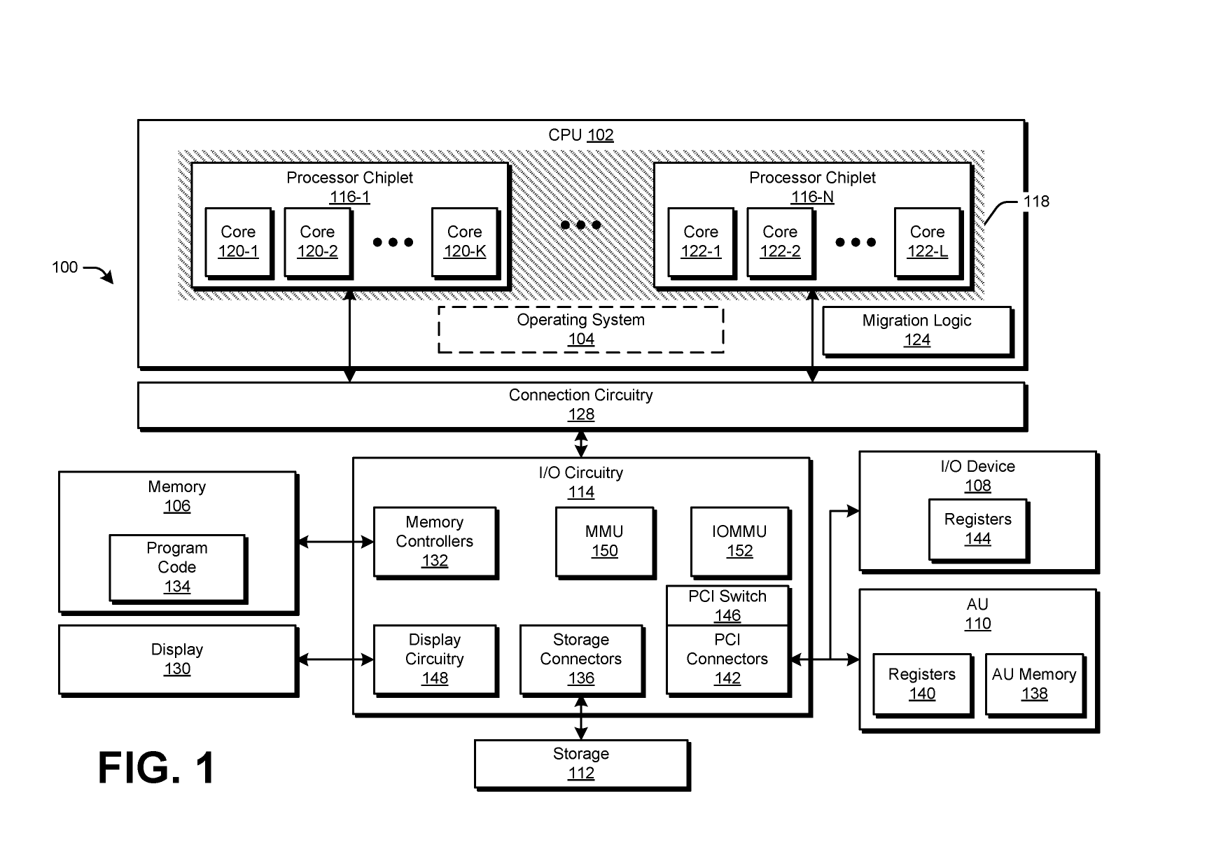

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations. Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

In this example, migration logic 124 is depicted in the CPU 102 of the processing system 100. Broadly, the migration logic 124 corresponds to or includes one or more algorithm(s) embodied in executable instructions implemented in software and/or firmware which when executed by the CPU 102 cause the CPU 102 to perform operations for migrating a virtual machine from a source server to a destination server. In variations, however, the migration logic 124 is included in and/or is implemented by one or more different components of the processing system 100, such as the memory 106, the I/O device 108, the AU 110, the storage 112, the I/O circuitry 114, and so forth. In at least one implementation, the migration logic 124 or portions of the migration logic 124 are included in at least two of the depicted components of the processing system 100. By way of example, the migration logic 124 may be included in or otherwise implemented by at least the CPU 102, the AU 110, and the I/O circuitry 114.

Additionally, within the processing system 100, the CPU 102 is communicatively coupled to an I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 132 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 134 (e.g., an executable file) associated with the application from, for example, a storage 112 into system memory 106. This storage 112, for example, includes a non-volatile storage such as a flash memory, solid-state memory, hard disk, optical disc, or the like configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 146 and input-output memory management unit (IOMMU) 148. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

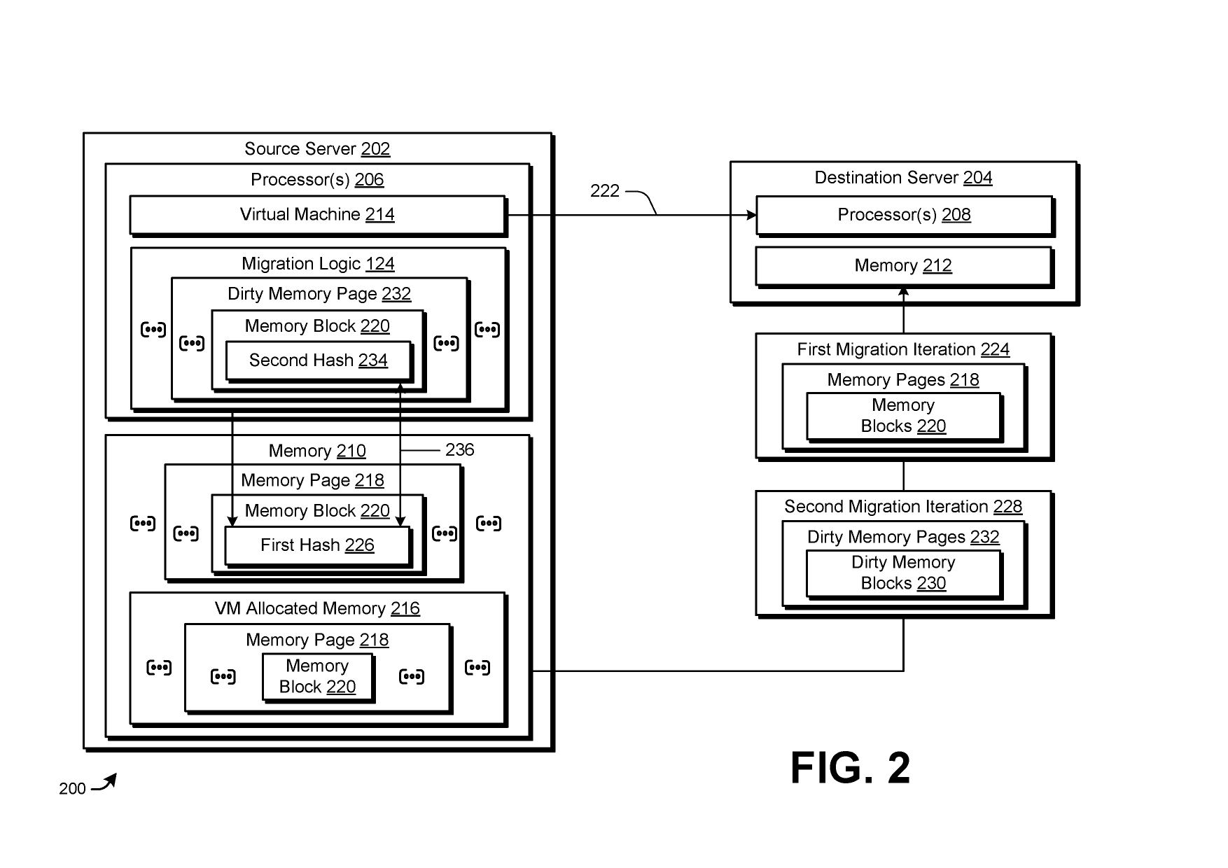

FIG. 2 is a block diagram of a non-limiting example system 200 to implement dirty data tracking for live migration of virtual machines. In various examples, the system 200 is a data center including a plurality of servers, such as the source server 202 and the destination server 204. The source server 202 and the destination server 204 are coupled to one another via wired or wireless connections. Examples of wired connections include but are not limited to including ethernet cables, fiber optic cables, InfiniBand cables, Direct Attached Copper (DAC) cables, and Twinax Cables.

As shown, the source server 202 includes one or more processors 206, and the destination server 204 includes one or more processors 208. The processors 206, 208 are electronic circuits configured to read, translate, and execute, instructions of an application, a virtual machine, an operating system, and/or a hypervisor. Examples of the processors 206, 208 include central processing units (CPUs), graphics processing units (GPUs), digital signal processors (DSPs), application-specific integrated circuits (ASICs), field-programmable gate arrays (FPGAs), acceleration processors, neural processing units (NPUs), cryptographic accelerators, and the like.

Furthermore, the source server 202 includes a memory 210, and the destination server 204 includes a memory 212. The memory 210 is communicatively coupled to the one or more processors 206 via one or more wired and/or wireless connections, and the memory 212 is communicatively coupled to the one or more processors 208 via one or more wired and/or wireless connections. Example wired connections between the processors 206, 208 and the memories 210, 212, respectively, include buses (e.g., a data bus), interconnects, traces, and planes.

The memories 210, 212 are devices and/or systems that are used to store information, such as for use by the processors 206, 208, respectively. In at least one example, the memories 210, 212 correspond to or include volatile memory, examples of which include random-access memory (RAM), dynamic random-access memory (DRAM), synchronous dynamic random-access memory (SDRAM), and static random-access memory (SRAM). Alternatively or in addition, the memories 210, 212 correspond to or include non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). Thus, the memories 210, 212 are configurable in a variety of ways that support dirty data tracking for live migration of virtual machines.

In various examples, the processing system 100 of FIG. 1 is representative of a server (or portion of a server) of the data center, e.g., the source server 202 and the destination server 204. By way of example, the source server 202 includes an instance of the processing system 100, and the destination server 204 includes an instance of the processing system 100. Thus, the processors 206, 208 each include the CPU 102 and/or one or more AUs 110 of the processing system 100, and the memories 210, 212 each include and/or correspond to the memory 106. In variations, however, the source server 202 and the destination server 204 range in processing abilities from relatively small to relatively large, e.g., the servers 202, 204 are single processor cores, groupings of processor cores, single processors, multiple processors, a system-on-a-chip (SoC) such as the processing system 100, and/or a server computer having multiple SoCs such as multiple instances of the processing system 100.

As shown, the source server 202 is configured to run a virtual machine 214, e.g., on the processor(s) 206. Broadly, virtual machines 214 are software emulations of physical computers that each run an operating system (e.g., a guest operating system) in an isolated execution environment. For instance, the processor(s) 206 include a host processor (e.g., the CPU 102) that runs a hypervisor (not shown) for managing execution of virtual machines 214 on the source server 202. As part of this, the hypervisor allocates hardware resources (e.g., processing resources of the processor(s) 206 and memory resources of the memory 210) to individual virtual machines 214. Further, the operating system of an individual virtual machine 214 utilizes the allocated hardware resources to execute software programs and/or applications. Virtual machines 214 thus allow multiple operating systems to run on a single physical machine (e.g., a single processor 206 or processor core), thereby improving flexibility, scalability and resource utilization for the system 200.

As part of allocating the hardware resources to the virtual machine 214, the hypervisor allocates a dedicated portion of the memory 210 to the virtual machine 214, e.g., the virtual machine (VM) allocated memory 216. As shown, the VM allocated memory 216 includes a plurality of memory pages 218, and each memory page 218 includes a plurality of memory blocks 220. Broadly, memory pages 218 and memory blocks 220 are fixed-size portions of the memory 210 (e.g., physical memory), such that the memory pages 218 are larger in size than the memory blocks 220. In one specific but non-limiting example, the memory pages 218 are four kilobytes while the memory blocks 220 are one hundred twenty-eight bits, and as such, each memory page 218 includes two hundred fifty-six memory blocks 220.

In one or more implementations, the source server 202 is configured to transfer the virtual machine 214 from running on the source server 202 to running on the destination server 204 using live migration techniques. In accordance with live migration, the virtual machine 214 continues to run on the source server 202 while the VM allocated memory 216 is copied to the destination server 204. In this way, the virtual machine 214 remains operational throughout the live migration process with minimal downtime. Live migration of the virtual machine 214, therefore, ensures that service level agreements (SLAs) associated with the guest operating system running of the virtual machine 214 are met while the virtual machine 214 is migrated from the source server 202 to the destination server 204 for purposes of load balancing, performing maintenance and/or platform upgrades on the source server 202, and the like.

Conventional techniques for live migration, however, consume excess network bandwidth and power, and prolong downtime of the virtual machine 214. One such conventional technique is pre-copy live migration. In accordance with conventional pre-copy live migration, the VM allocated memory 216 is iteratively copied over multiple migration iterations from the source server 202 to the destination server 204, while the virtual machine 214 continues to run on the source server 202. In each migration iteration, the memory pages 218 that were written to since the previous migration iteration (e.g., dirty memory pages) are transferred to the destination server 204. In contrast, the memory pages 218 that are unmodified since the previous migration iteration (e.g., clean memory pages) are not transferred to the destination server 204. Generally, the number of pages to be copied to the destination server 204 is reduced as the live migration process progresses, e.g., later migration iterations transfer fewer memory pages 218 than earlier migration iterations. During a final migration iteration, the virtual machine 214 is briefly paused while the remaining memory pages 218 are copied to the destination server 204, e.g., a blackout period. Thereafter, the virtual machine 214 resumes executing on the processor(s) 208 of the destination server 204 using the data of the VM allocated memory 216 that has been transferred to and stored in the memory 212 of the destination server 204.

However, conventional pre-copy live migration tracks dirty data at memory-page-level granularity. Given this, the entire memory page 218 is transferred to the destination server 204 when the memory page 218 is detected as including dirty data (e.g., data that has been modified during a previous migration iteration) regardless of the amount of dirty data in the memory page 218. Thus, the system 200 incurs excess network bandwidth consumption and power consumption transferring an entire memory page 218 when just a portion of the memory page 218 is dirty. Furthermore, pre-copy live migration inflates downtime of the virtual machine 214 during the blackout period in scenarios in which a relatively small amount of dirty data is spread across multiple memory pages 218.

These problems are further exacerbated in implementation scenarios in which the memory pages 218 being transferred are secured via encryption. In these scenarios, the source server 202 decrypts encrypted data of the memory page 218 stored in memory 210 using a private key of the source server 202, and re-encrypts the data of the memory page 218 for transportation to the destination server 204 using a migration key that is shared between the source server 202 and the destination server 204. Furthermore, the destination server 204 decrypts the data of the memory page 218 using the migration key, and encrypts the data of the memory page 218 using a private key of the destination server 204 for storage in the memory 212. These multiple rounds of encryption and decryption using different keys, however, add latency to each migration iteration, and the latency increases in correlation with the amount of data (e.g., number of memory pages 218) being transferred.

Accordingly, techniques are discussed herein to transfer dirty memory blocks 220 of a memory page 218 to the destination server 204, and refrain from transferring clean memory blocks 220 of the memory page 218 during a migration iteration. As used herein, the term “dirty data” refers to data that has been modified and/or written to at the source server 102 since a previous migration iteration of the live migration process, and as such, the corresponding data at the destination server 204 is inaccurate. Similarly, the term “dirty memory block” refers to a memory block 220 that has been modified and/or written to since a previous migration iteration of the live migration process, i.e., a memory block 220 that contains dirty data. Likewise, the term “dirty memory page” refers to a memory page 218 that has been modified and/or written to since a previous migration iteration of the live migration process, i.e., a memory page 218 that contains dirty data. In accordance with the described techniques, therefore, the VM allocated memory 216 is iteratively copied over multiple migration iterations from the source server to the destination server 204. In each migration iteration, only the dirty memory blocks that were written to since the previous migration iteration (e.g., dirty memory pages) are transferred to the destination server 204.

In accordance with the described techniques, the source server 202 is configured to migrate the virtual machine 214 from executing on the processor(s) 206 of the source server 202 to executing on the processor(s) 208 of the destination server 204, as shown at 222. As part of this, the source server 202 includes migration logic 124 (e.g., one or more algorithm(s) embodied in executable instructions implemented in software and/or firmware) which when executed by the processor(s) 206 cause the processor(s) 206 to perform operations for migrating the virtual machine 214 to the destination server 204.

During a first migration iteration 224, the migration logic 124 is configured to transfer each memory block 220 of each memory page 218 of the VM allocated memory 216 to the destination server 204, as shown. Before doing so, the migration logic 124 encrypts the data contained within the memory pages 218 for transportation to the destination server 204 using an authenticated encryption function, such as a modified version of the Advanced Encryption Standard – Galois/Counter Mode (AES-GCM).

To encrypt a memory page 218 in accordance with traditional AES-GCM, the data of the memory page 218 is encrypted in fixed-size memory chunks (e.g., one hundred twenty-eight bits) using a migration key. For instance, each memory chunk is encrypted by converting unencrypted (e.g., plaintext) data of the memory chunk to encrypted (e.g., ciphertext) data of the memory chunk. In addition, a first encrypted memory chunk is hashed using a hashing function to generate a first intermediate hash. Next, the first intermediate hash is combined with a second encrypted memory chunk (e.g., using an XOR operation), and the result is hashed using the hashing function to generate a second intermediate hash. This process is repeated sequentially for each memory chunk of the memory page 218, until an authentication tag (e.g., an intermediate hash of a final memory chunk) is generated. In conventional AES-GCM, therefore, each intermediate hash is dependent on data contained in previous memory chunks of the memory page 218.

In accordance with the described techniques, however, the migration logic 124 encrypts the data of the memory pages 218 using a modified version of AES-GCM. To encrypt a memory page 218 in accordance with the modified AES-GCM protocol, the migration logic 124 encrypts each fixed size (e.g., one hundred twenty-eight bits) memory chunk in the memory page 218 by converting unencrypted (e.g., plaintext) data of the memory chunk to encrypted (e.g., ciphertext) data of the memory chunk, similar to traditional AES-GCM. Further, each encrypted memory chunk is hashed using a hashing function to generate a unique hash for the encrypted memory chunk. Unlike traditional AES-GCM, however, the unique hash of each encrypted memory chunk is not based on an intermediate hash from a previous encrypted memory chunk. For instance, an encrypted memory chunk of the modified AES-GCM protocol is not first combined (e.g., using an XOR operation) with the intermediate hash of a previous encrypted memory chunk in order to generate the unique hash for the encrypted memory chunk. In accordance with the modified AES-GCM protocol, therefore, the unique hashes of the memory chunks in the memory page 218 are independent of other memory chunks in the memory page 218.

Although the modified AES-GCM protocol is discussed herein as an example, this example is not to be construed as limiting. Indeed, any of a variety of public or proprietary encryption and/or authenticated encryption algorithms are usable to generate encrypted data of a memory page being transferred during live migration. Furthermore, any of a variety of public or proprietary hashing functions are usable to generate unique hashes for the encrypted data. Additionally or alternatively, any of a variety of public or proprietary hashing functions are applicable to generate unique hashes of unencrypted data of a memory page being transferred during live migration. In various examples, the authenticated encryption algorithm(s) (e.g., the modified AES-GCM protocol) are executed, at least partially, in hardware of the source server 202, e.g., by the processor(s) 206.

During the first migration iteration 224, the migration logic 124 encrypts each memory page 218 of the VM allocated memory 216 using the modified AES-GCM protocol. In doing so, the migration logic 124 generates a unique hash for each memory chunk. Using the unique hashes, the migration logic 124 is configured to generate a first hash 226 for each memory block 220 of each memory page 218. In various implementation scenarios, the memory blocks 220 correspond in size with the memory chunks on which the authenticated encryption is performed, e.g., the memory blocks 220 and the memory chunks are both one hundred twenty-eight bits. In these scenarios, the first hash 226 of a memory block 220 is the unique hash of the memory chunk corresponding to the memory block 220.

In alternative implementation scenarios, the memory blocks 220 are larger in size than the memory chunks on which the authenticated encryption is performed. In other words, multiple memory chunks fit within each memory block 220. For instance, the memory block 220 is five hundred twelve bits and four one hundred twenty-eight bit memory chunks fit in the memory block 220. In these scenarios, the migration logic 124 is configured to generate a first hash 226 for each memory block 220 by combining the unique hashes of the memory chunks contained within the memory block 220. By combining the unique hashes in this manner, the first hash 226 is the same length as a singular unique hash of a singular memory chunk (e.g., one hundred twenty-eight bits) but represents the multiple memory chunks contained within the memory block 220. As used herein, the term “memory chunks” refers to a fixed length portions of memory 210 that are authenticated and hashed by an authenticated encryption algorithm, e.g., modified AES-GCM. Similarly, a memory block 220 is a fixed-length portion of the memory 210, but the memory block 220 can be the same size or larger than a memory chunk.

Once the first hashes 226 are generated, the migration logic 124 stores the first hashes 226 in memory 210 of the source server 202. As shown, each memory block 220 of each memory page 218 includes a first hash 226. In accordance with the modified AES-GCM protocol, the migration logic 124 additionally generates an authentication tag for each memory page 218 by combining the first hashes 226 of the memory blocks 220 within the memory page 218 using a secure hash combination function. For example, the migration logic 124 generates a Merkle tree using the first hashes 226 of a memory page 218, and the authentication tag for the memory page 218 is a root of the Merkle tree. Furthermore, the source server 202 transfers the encrypted data of each memory page 218, the authentication tag of each memory page 218, and the migration key to the destination server 204.

Here, the destination server 204 receives the encrypted data of a memory page 218 and generates a validation key by attempting to regenerate the authentication tag using the authenticated encryption function (e.g., the modified AES-GCM protocol) based on the encrypted data and the migration key. If the validation tag matches the authentication key, the destination server 204 authenticates the transferred memory page 218 as having not been tampered with during migration to the destination server 204. Once authenticated, the destination server 204 decrypts the encrypted data using the migration key, re-encrypts the data using a private key of the destination server 204, and stores the re-encrypted data in the memory 210. This process is repeated for each memory page 218 transferred during the first migration iteration 224.

After the first migration iteration 224 has completed, the source server 202 marks all memory pages 218 of the VM allocated memory 216 as clean in a page tracking data structure maintained in memory 210 of the source server 202. Broadly, the page tracking data structure indicates whether the memory pages 218 have been modified since a previous migration iteration. In various examples, the page tracking data structure is a page table including a page table entry (PTE) for each memory page 218, and each PTE includes a dirty bit indicating whether the corresponding memory page 218 has been modified since a previous migration iteration. In various examples, the source server 202 includes the MMU 150 and/or IOMMU 152 which are electronic circuits designed to manage the page tracking data structure, such as by marking dirty bits of the PTEs as clean or dirty. In various high security scenarios, the page tracking data structure is hidden from the hypervisor, e.g., the hypervisor is unable to access the page tracking data structure to mark pages as clean or dirty.

During a second migration iteration 228, the migration logic 124 is configured to transfer the dirty memory blocks 230 of the dirty memory pages 232 that have been modified since the first migration iteration 224, as shown. In doing so, the migration logic 124 is configured to refrain from transferring clean memory pages 218 and clean memory blocks 220 of dirty memory pages 232 that have not been modified since the first migration iteration 224. Notably, the second migration iteration 228 occurs subsequently to the first migration iteration 224.

During the second migration iteration 228, the migration logic 124 identifies, as the dirty memory pages 232, the memory pages 218 marked as dirty in the page tracking data structure. Furthermore, the migration logic 124 encrypts the data of the dirty memory pages 232 in accordance with the modified AES-GCM protocol. In doing so, the migration logic 124 generates a unique hash for each memory chunk of the dirty memory pages 232, and generates a second hash 234 for each memory block 220 of the dirty memory pages 232 using the unique hashes. In one variation, the memory blocks 220 correspond in size to the memory chunks, and a second hash 234 of a memory block 220 is the unique hash of a corresponding memory chunk. In an alternative variation, the memory blocks 220 are larger in size than the memory chunks, and a second hash 234 of a memory block 220 is a combination of the unique hashes of the multiple memory chunks contained in the memory block 220.

As shown at 236, the migration logic 124 compares the second hashes 234 of each memory block 220 of the dirty memory pages 232 to the first hashes 226 of corresponding memory blocks 220 in memory 210. Given a particular memory block 220 of a dirty memory page 232, for instance, the migration logic 124 compares the second hash 234 of the particular memory block 220 to the first hash 226 of the particular memory block 220 stored in the memory 210. Furthermore, the migration logic 124 identifies the memory block 220 as a dirty memory block 230 if the second hash 234 is different from the first hash 226. As mentioned above, the second hash 234 of a memory block 220 is dependent on data contained in the memory block 220, but is independent of data contained in other memory blocks 220 of the memory page 218. Given this, the second hash 234 being different from the first hash 226 indicates that the data of the particular memory block 220 has been modified since the first migration iteration 224. Contrarily, the migration logic 124 identifies the particular memory block 220 as a clean memory block 220 based on the second hash 234 equaling the first hash 226. This process is repeated for each memory block 220 in each dirty memory page 232 to identify the dirty memory blocks 230.

Once the dirty memory blocks 230 are identified, the migration logic 124 replaces the first hashes 226 of the dirty memory blocks 230 in the memory 210 with updated hashes generated based on the modified data contained in the dirty memory blocks 230. Further, the migration logic 124 generates an authentication tag for each dirty memory page 232 by combining the updated hashes of the dirty memory blocks 230 (e.g., but not the clean memory blocks) in the dirty memory page 232 using the secure hash combination function. Moreover, the source server 202 transfers the encrypted data of each dirty memory block 230 of each dirty memory page 232, the authentication tag of each dirty memory page 232, and the migration key. However, the source server 202 does not transfer clean memory pages 218 or clean memory blocks 220 of dirty memory pages 232 during the second migration iteration 228.

Here, the destination server 204 receives the encrypted data of the dirty memory blocks 230 of a dirty memory page 232. Furthermore, the destination server 204 generates a validation tag by attempting to regenerate the authentication tag using the authenticated encryption function (e.g., the modified AES-GCM protocol) based on the encrypted data and the migration key. If the validation key and the authentication key match, then the transferred data is authenticated as not having been tampered with during transportation to the destination server 204. Once authenticated, the destination server 204 decrypts the data using the migration key, re-encrypts the data using the private key of the destination server 204, and stores the re-encrypted data in memory 210. For example, the destination server 204 replaces the data of the dirty memory blocks 230 transferred during the first migration iteration 224 with the data of the dirty memory blocks 230 transferred during the second migration iteration 228. This process is repeated for each dirty memory page 232.

The processes of the second migration iteration 228 are iteratively repeated over a plurality of migration iterations. In each subsequent migration iteration, the migration logic 124 generates hashes for memory blocks 220 of dirty memory pages 232 that have been modified since a previous migration iteration. Furthermore, the migration logic 124 compares the generated hashes to the hashes stored in the memory 210 that were updated during the previous migration iteration. Moreover, the migration logic 124 identifies dirty memory blocks 230 that have been modified since the previous migration iteration based on the generated hashes of the memory blocks 220 differing from corresponding stored hashes. During the subsequent migration iteration, the dirty memory blocks 230 that have been modified since the previous migration iteration are transferred to the destination server 204. During a final migration iteration, the virtual machine 214 is paused briefly on the source server 202 while the remaining dirty memory blocks 230 (and not clean memory pages 218 or clean memory blocks 220 of dirty memory pages 232) are transferred to the destination server 204. Finally, the virtual machine 214 resumes executing on the processor(s) 208 of the destination server 204, e.g., with a hypervisor of the destination server 204 managing resource allocation to the virtual machine 214.

Accordingly, the described techniques reduce network bandwidth and power consumption as compared to conventional pre-copy live migration. This is because, in each subsequent migration iteration, the described techniques transfer solely the dirty memory blocks 230 rather than the dirty memory pages 232 in their entirety including clean memory blocks 220. In other words, the described techniques reduce the amount of data transferred in each subsequent migration iteration which reduces network bandwidth consumption and power consumption. Similarly, the described techniques reduce downtime of the virtual machine 214 during the blackout period because solely the dirty memory blocks 230 are transferred during the final migration iteration, rather than the dirty memory pages 232 in their entirety including clean memory blocks 220.

Moreover, the described techniques track the dirty memory blocks 230 without impacting runtime performance of the virtual machine 214 by tracking the dirty memory blocks 230 using the hashes 226, 234. This is because the hashes 226, 234 are generated by the authenticated encryption algorithm regardless of whether dirty data tracking occurs at memory-page-level granularity or memory-block-level granularity, and as such, leveraging the hashes 226, 234 for dirty data tracking does not add runtime overhead to the virtual machine 214. This contrasts with alternative approaches that track dirty memory blocks in the page tracking data structure, and therefore incur additional overhead by way of the virtual machine 214 marking memory blocks 220 as dirty in the page tracking data structure when data is written to the VM allocated memory 216.

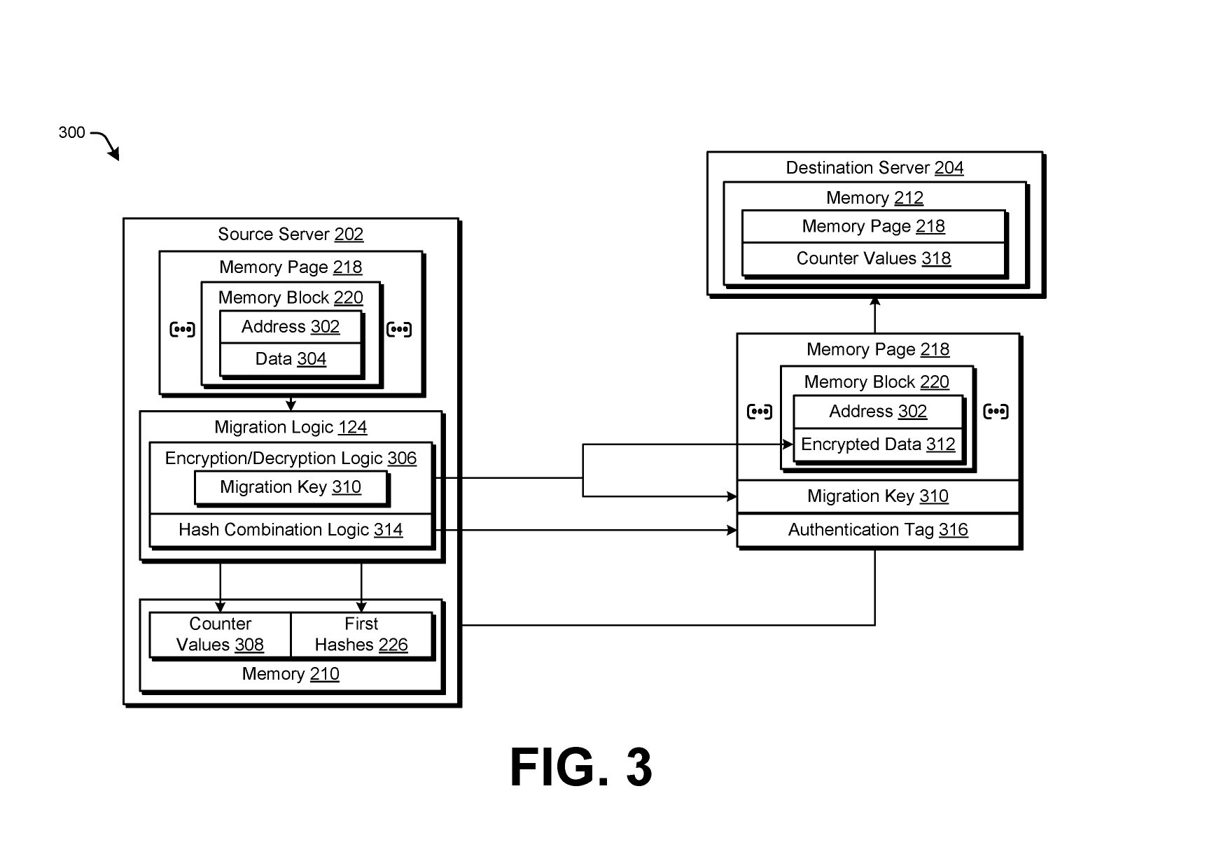

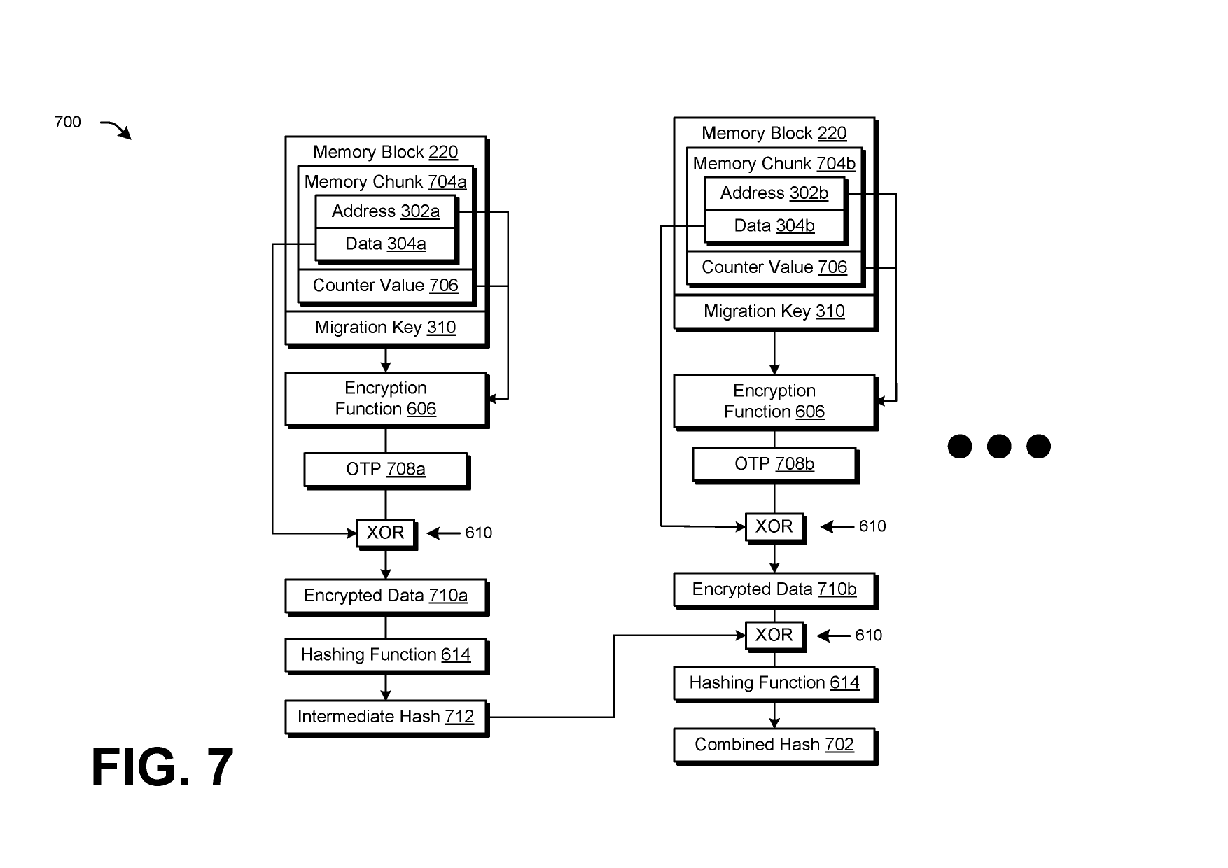

FIG. 3 depicts an example 300 of a source server transferring a memory page allocated to a virtual machine to a destination server during a first migration iteration of a live migration process for the virtual machine. In the following discussion of FIGS. 3-6, examples are described and depicted in which the memory blocks 220 correspond to the memory chunks on which the authenticated encryption is performed, e.g., the memory blocks 220 and the memory chunks are both one hundred twenty-eight bits. However, these examples are not to be construed as limiting. Instead, as further discussed below with reference to FIG. 7, the memory blocks 220 contain multiple memory chunks on which the authenticated encryption is performed in various implementations.

In the example 300, the migration logic 124 receives a memory page 218. As shown, the memory page 218 includes a plurality of memory blocks 220, and each memory block 220 includes an address 302 (e.g., a memory address) and data 304 (e.g., unencrypted data) that is contained within the memory block 220. Here, the migration logic 124 includes encryption/decryption logic 306, which is generally configured to implement the modified AES-GCM protocol to encrypt data being transported to the destination server 204 during live migration of the virtual machine 214. In accordance with the modified AES-GCM protocol, each memory block 220 is assigned a counter value 308 that represents a number of times that the memory block 220 has been modified over consecutive migration iterations. Thus, during the first migration iteration 224, the encryption/decryption logic 306 initializes the counter values 308 to zero, and the counter values 308 are stored in memory 210 of the source server 202.

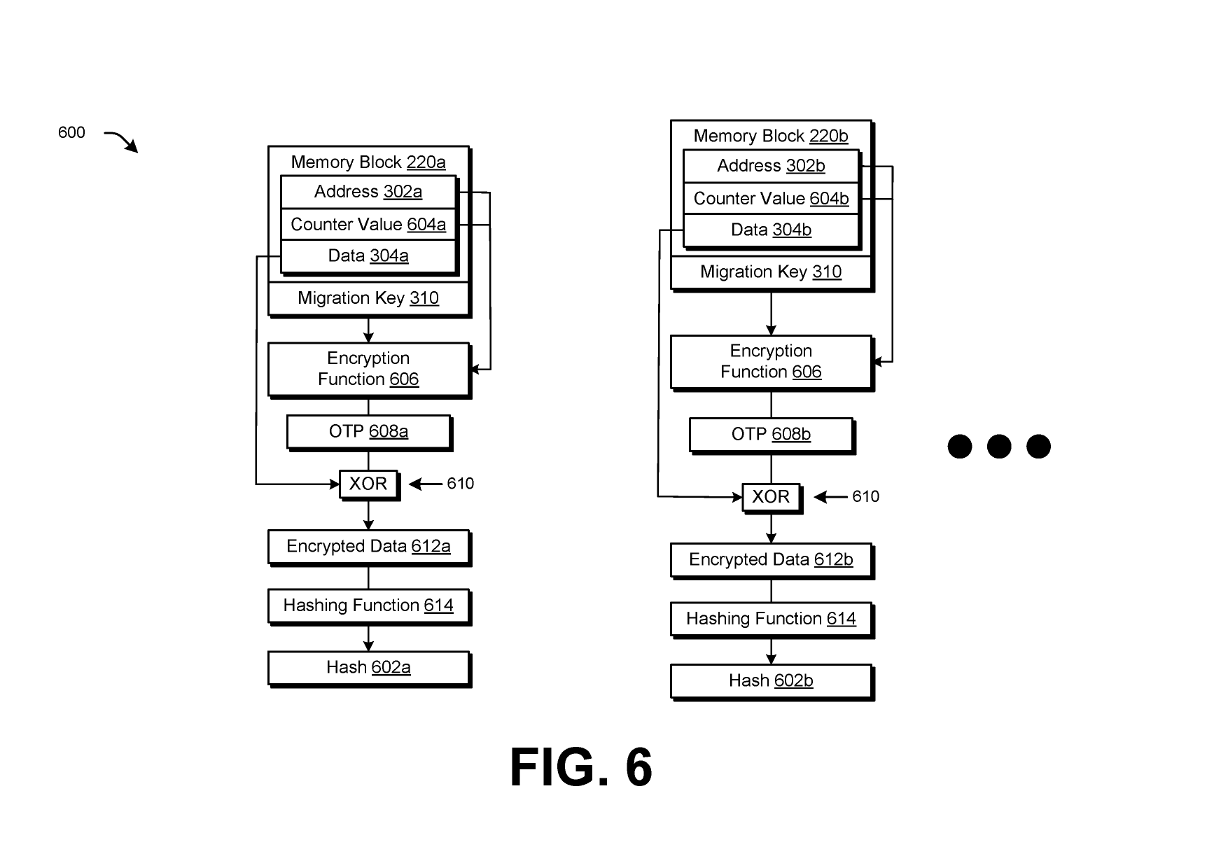

To encrypt a memory block 220 in accordance with the modified AES-GCM protocol, the encryption/decryption logic 306 receives, as input, the address 302 of the memory block 220, the data 304 of the memory block 220, the counter value 308 of the memory block 220, and a migration key 310. Broadly, the encryption/decryption logic 306 generates encrypted data 312 of the memory block 220 by encrypting the data 304 based on the address 302, the counter value 308, and the migration key 310, as further explained below with reference to FIG. 6. As part of generating the encrypted data 312, the encryption/decryption logic 306 generates a first hash 226 of the memory block 220 by applying a hash function to the encrypted data 312. This process is repeated for each memory block 220 of the memory page 218. For example, the encryption/decryption logic 306 generates encrypted data 312 for each memory block 220 of the memory page 218, and generates a first hash 226 of the encrypted data 312 for each memory block 220 of the memory page 218. As shown, the first hashes 226 are stored in the memory 210 of the source server 202.

The migration logic 124 additionally includes hash combination logic 314, which is generally configured to implement the secure hash combination function to generate an authentication tag 316, as shown. By way of example, the hash combination logic 314 generates a Merkle tree using the first hashes 226, and extracts, as the authentication tag 316, a root of the Merkle tree. Although a Merkle tree is described herein as an example of the secure hash combination function, this example is not to be construed as limiting. Rather, any of a variety of public or proprietary secure hash combination functions are usable by the hash combination logic 314, one example of which is a hash list.

In accordance with the described techniques, the source server 202 transfers the memory page 218 including the encrypted data 312 of each memory block 220. The source server 202 additionally communicates the migration key 310 and the authentication tag 316 to the destination server 204. Here, the destination server 204 stores its own set of counter values 318 in memory 212 of the destination server 204. Like the counter values 308 at the source server 202, each memory block 220 is assigned a counter value 318 at the destination server 204, and the counter values 318 are initialized to zero. Using the modified AES-GCM protocol, the destination server 204 generates a validation tag by attempting to regenerate the authentication tag 316 based on the encrypted data 312 of the memory blocks 220, the addresses 302 of the memory blocks 220, the migration key 310, and the counter values 318. If the validation tag matches the authentication tag 316, the destination server 204 decrypts the encrypted data 312 using the migration key 310. Furthermore, the destination server 204 re-encrypts the data using a private key of the destination server 204, and stores the re-encrypted data of the memory page 218 in the memory 212, as shown. After the first migration iteration 224, the source server 202 marks the memory page 218 as clean in the page tracking data structure.

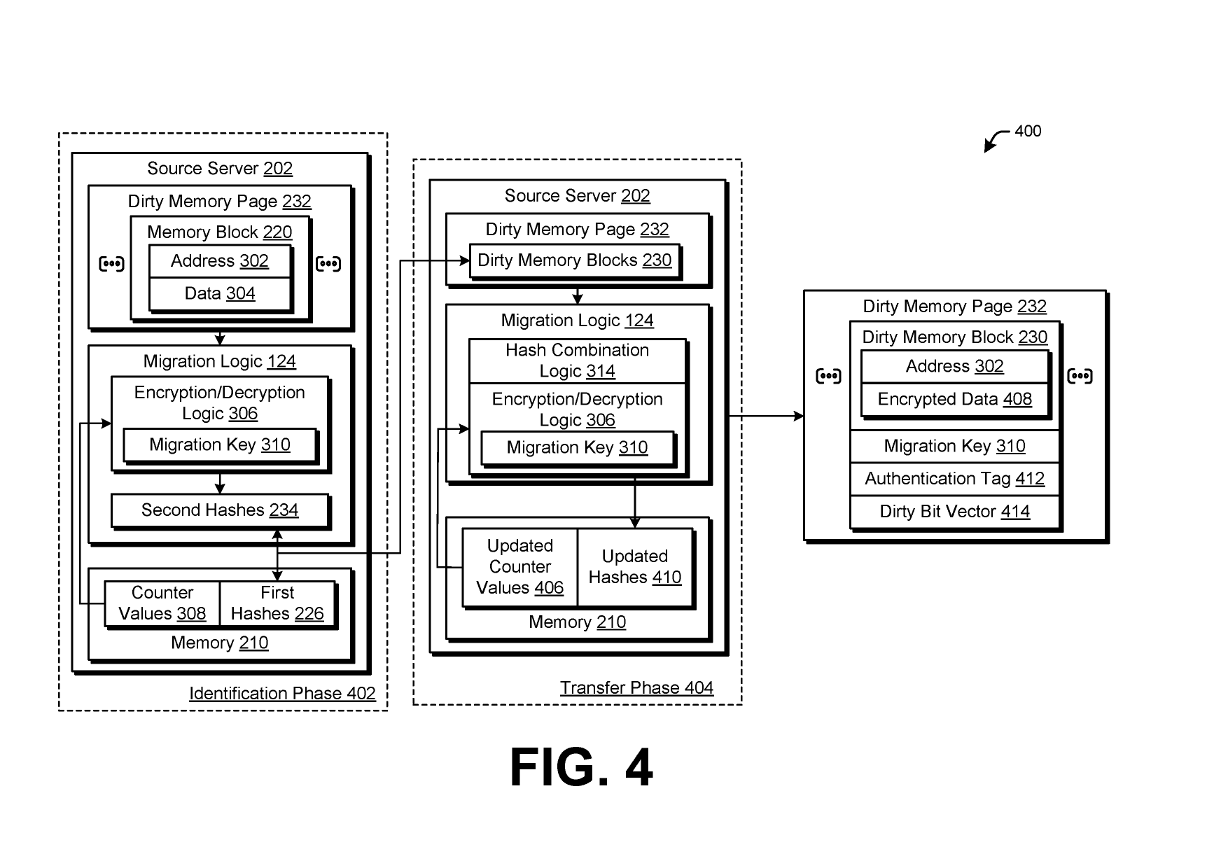

FIG. 4 depicts an example 400 of the source server transferring the memory page allocated to the virtual machine to a destination server during a subsequent migration iteration of the live migration process of the virtual machine. In the example 400, the source server 202 identifies the memory page 218 as a dirty memory page 232. For example, the source server 202 (e.g., the MMU and/or IOMMU of the source server 202) marks the memory page 218 as dirty in the page tracking data structure based on data having been written to the memory page 218 since the first migration iteration 224. Furthermore, the source server 202 determines that the memory page 218 is dirty based on the memory page 218 being marked as dirty in the page tracking data structure.

In accordance with the described techniques, the source server 202 transfers the dirty memory blocks 230 of the dirty memory page 232 in two phases – an identification phase 402, and a transfer phase 404. Broadly, the source server 202 identifies the dirty memory blocks 230 during the identification phase 402, and the source server 202 encrypts the data of the dirty memory blocks 230 for transportation to the destination server 204 during the transfer phase 404. Upon identifying the dirty memory page 232, the encryption/decryption logic 306 is configured to encrypt the data 304 of each memory block 220 using the stored counter values 308 and the modified AES-GCM protocol. Given a memory block 220 of the dirty memory page 232, for instance, the encryption/decryption logic 306 receives, as input, the address 302 of the memory block 220, the data 304 of the memory block 220, the counter value 308 of the memory block 220, and the migration key 310. Furthermore, the encryption/decryption logic 306 encrypts the data 304 based on the address 302, the counter value 308, and the migration key 310. In doing so, the encryption/decryption logic 306 generates a second hash 234 of the memory block 220 by applying a hash function to the encrypted data. This process is repeated to generate a second hash 234 for each memory block 220 of the dirty memory page 232.

Also during the identification phase 402, the migration logic 124 compares the second hashes 234 to the first hashes 226 stored in memory 210. To determine whether a memory block 220 is dirty, the migration logic 124 compares the second hash 234 of the memory block 220 to the first hash 226 of the memory block 220 stored in memory 210. If the first hash 226 and the second hash 234 are equal, then the migration logic 124 determines that the memory block 220 is clean and refrains from transferring the memory block 220 to the destination server 204 during the current migration iteration. If the first hash 226 and the second hash 234 are different, the migration logic 124 identifies the memory block 220 as a dirty memory block 230 to be transferred to the destination server 204 during the current migration iteration. This process is repeated to determine whether each memory block 220 of the dirty memory page 232 is clean or dirty.

During the transfer phase 404, the migration logic 124 is configured to increment the counter values 308 associated with the dirty memory blocks 230 in the memory 210. As a result, the source server 202 stores updated counter values 406 in the memory 210, in which the counter values of the dirty memory blocks 230 are incremented (e.g., by a value of one) and the counter values of the clean memory blocks 220 are unchanged.

In addition, the encryption/decryption logic 306 re-encrypts the data 304 of each dirty memory block 230 using the updated counter values 406 and the modified AES-GCM protocol. Given a dirty memory block 230, for instance, the encryption/decryption logic 306 receives, as input, the address 302 of the dirty memory block 230, the data 304 of the dirty memory block 230, the incremented/updated counter value 406 of the dirty memory block 230, and the migration key 310. Furthermore, the encryption/decryption logic 306 generates encrypted data 408 of the dirty memory block 230 by re-encrypting the data 304 of the dirty memory block 230 based on the address 302, the incremented/updated counter value 406, and the migration key 310. In doing so, the encryption/decryption logic 306 generates an updated hash 410 of the memory block 220 by applying a hash function to the encrypted data 408. Furthermore, the migration logic 124 stores the updated hash 410 in memory 210 by replacing the first hash 226 of the dirty memory block 230 with the updated hash 410. This process is repeated to generate encrypted data 408 for each dirty memory block 230 of the dirty memory page 232, and to generate an updated hash 410 for each dirty memory block 230 of the dirty memory page 232. As a result, the source server 202 stores a set of updated hashes 410, in which the hashes of the dirty memory blocks 230 are updated/incremented and the hashes of the clean memory blocks 220 are unchanged from the previous migration iteration, e.g., the hashes of the clean memory blocks 220 are the first hashes 226.

By regenerating the encrypted data 408 using the updated counter value 406 rather than the old counter value 308, the described techniques significantly reduce the possibility of generating the same encrypted data 408 during multiple migration iterations, which improves security of the encrypted data 408 being transported. While the described techniques involve generating encrypted data and hashes twice for the dirty memory blocks 230 during the subsequent migration iteration, these operations do not lie on the critical path impacting runtime performance of the virtual machine 214. To accelerate this process, the source server 202 is configured to offload the generation and regeneration of the encrypted data and the hashes for the memory blocks 220 during the subsequent migration iteration to hardware accelerators (e.g., acceleration processors 206) in one or more implementations.

Also during the transfer phase 404, the hash combination logic 314 is configured to generate an authentication tag 412 by combining the updated hashes 410 of the dirty memory blocks 230 using the secure hash combination function. For example, the hash combination logic 314 generates a Merkle tree using the updated hashes 410 of the dirty memory blocks 230, and extracts the root of the Merkle tree as the authentication tag 412. Notably, the hashes of clean memory blocks 220 are not used to generate the authentication tag 412.

In one or more implementations, the source server 202 generates a dirty bit vector 414 for the dirty memory page 232 during the transfer phase 404. The dirty bit vector 414 includes one bit for each memory block 220 of the dirty memory page 232 indicating whether the memory block 220 is clean or dirty. By way of example, each memory block 220 is assigned a bit position in the dirty bit vector 414. In this example, the migration logic 124 marks the assigned bit positions of dirty memory blocks 230 with a binary indicator of one, and marks the assigned bit positions of clean memory blocks 220 with a binary indicator of zero.

As shown, the source server 202 transfers encrypted data 408 and addresses 302 of the dirty memory blocks 230 of the dirty memory page 232 to the destination server 204. However, the source server 202 refrains from transferring data of clean memory blocks 220 of the dirty memory page 232. In addition, the source server 202 communicates the migration key 310, the authentication tag 412, and the dirty bit vector 414 to the destination server 204. In one or more examples, the source server 202 encrypts the dirty bit vector 414 before communicating the dirty bit vector to the destination server 204 using an authenticated encryption algorithm, e.g., traditional AES-GCM.

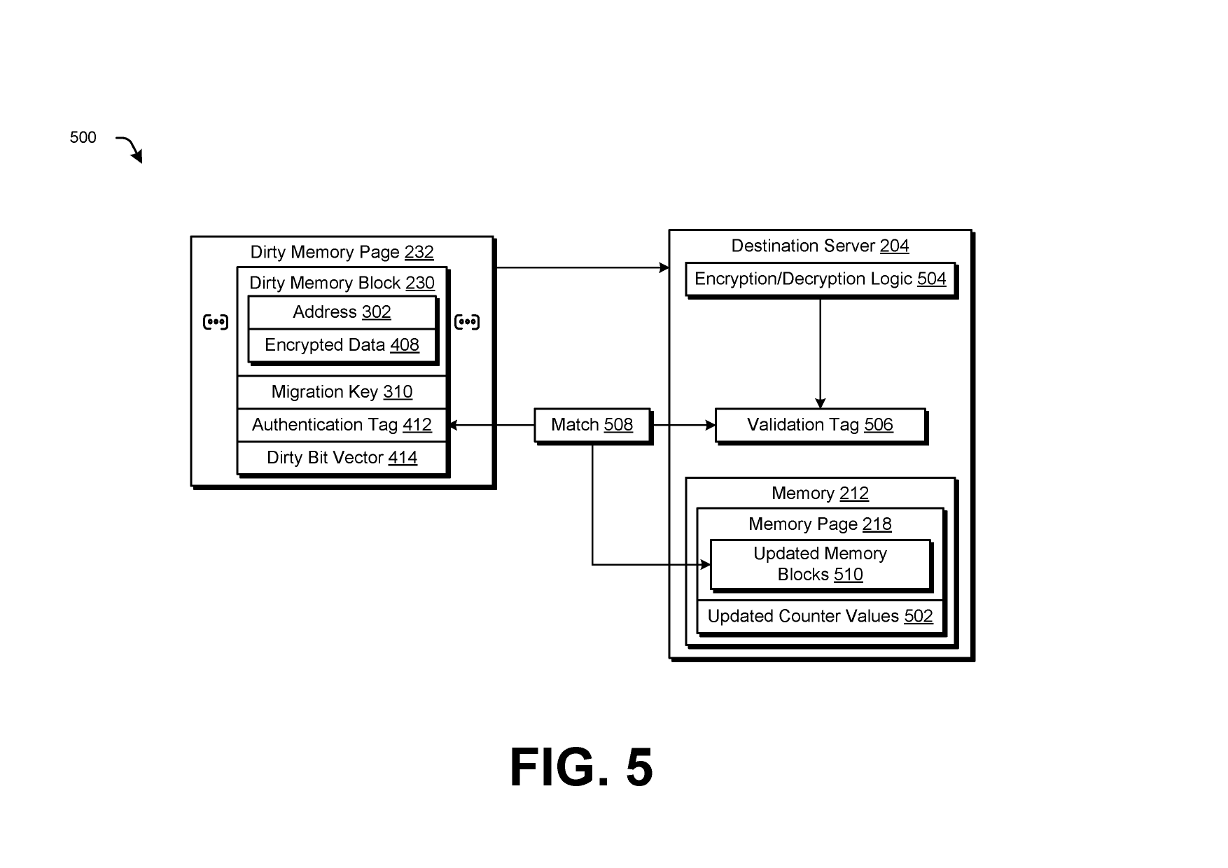

FIG. 5 depicts an example 500 of a destination server receiving the memory page allocated to the virtual machine during the subsequent migration iteration of the live migration process for the virtual machine. In the example 500, the destination server receives the addresses 302 and the encrypted data 408 of the dirty memory blocks 230 of the dirty memory page 232 from the source server 202. In addition, the destination server 204 receives the migration key 310, the authentication tag 412, and the dirty bit vector 414 from the source server 202.

Here, the destination server 204 decrypts the dirty bit vector using the authenticated encryption function, e.g., traditional AES-GCM. Thereafter, the destination server 204 identifies the dirty memory blocks 230 as the memory blocks in the dirty bit vector 414 that are marked as dirty. Furthermore, the destination server 204 increments the counter values 318 associated with the dirty memory blocks 230 in the memory 212. As a result, the destination server 204 stores updated counter values 502, in which the counter values of the dirty memory blocks 230 are incremented (e.g., by a value of one) and the counter values of the clean memory blocks 220 are unchanged.

Here, the destination server 204 includes encryption/decryption logic 504, which is generally configured to decrypt the encrypted data 408 being transported during live migration of the virtual machine 214 using the modified AES-GCM protocol. Here, the encryption/decryption logic 504 generates a validation tag 506. To do so, the encryption/decryption logic 504 receives, as input data, the addresses 302 of the dirty memory blocks 230, the encrypted data 408 of the dirty memory blocks 230, the updated counter values 502 of the dirty memory blocks 230, and the migration key 310. Furthermore, the encryption/decryption logic 504 attempts to regenerate the authentication tag 412 based on the received input data. The output of the regeneration attempt is the validation tag 506.

Furthermore, the destination server 204 compares the validation tag 506 to the authentication tag 412. If the validation tag 506 and the authentication tag 412 match 508, then the encryption/decryption logic 504 decrypts the encrypted data 408 using the migration key 310. Furthermore, the destination server 204 re-encrypts the data of the dirty memory blocks 230 using a private key of the destination server 204. The destination server 204 additionally replaces the data of the dirty memory pages 232 (e.g., as communicated during a previous migration iteration) with the re-encrypted data. As a result, the destination server 204 stores updated memory blocks 510 of the memory page 218 in the memory 210, in which the dirty memory blocks 230 include updated data and the clean memory blocks 220 are unchanged. It should be noted that, while the counter values of the memory blocks 220 are stored in memory 212 of the destination server 204, the hashes of the memory blocks 220 are not stored in the memory 212 of the destination server 204. In contrast to conventional pre-copy live migration, the destination server 204 decrypts and authenticates the dirty memory blocks 230 of the dirty memory page 232, and not the clean memory blocks 220 of the dirty memory page 232

FIG. 6 depicts an example 600 of generating hashes of memory blocks in accordance with one or more implementations. In the example 600, hashes 602a, 602b of memory blocks 220a, 220b are generated in accordance with the modified AES-GCM protocol. Further, the memory blocks 220a, 220b correspond in size to the memory chunks on which the authenticated encryption is performed in the example 600, e.g., the memory blocks 220a, 220b are one hundred twenty-eight bits, and the modified AES-GCM protocol is configured to perform authenticated encryption on one hundred twenty-eight bit memory chunks.

To generate the hash 602a, the address 302a of the memory block 220a, a counter value 604a of the memory block 220a, and a migration key 310 are provided as input to an encryption function 606 (e.g., the AES encryption algorithm) of the modified AES-GCM protocol. Based on the address 302a, the counter value 604a, and the migration key 310, the encryption function 606 generates a one-time pad (OTP) 608a for the memory block 220a. To do so, the counter value 604a and the address 302a are combined, and the encryption function 606 encrypts the combined data using the migration key 310. The output of this operation is the OTP 608a, which is a randomly generated value that is unique to the memory block 220a. Furthermore, the OTP 608a and the data 304a (e.g., the unencrypted data or plaintext) of the memory block 220a are combined using the exclusive OR (XOR) operation 610. The output of the XOR operation 610 is encrypted data 612a (or ciphertext) of the memory block 220a. Moreover, a hashing function 614 is applied to the encrypted data 612a to generate the hash 602a for the memory block 220a, as shown.

The hash 602b is generated in a similar manner. For example, the encryption function 606 receives, as input, the address 302b of the memory block 220b, the counter value 604b of the memory block 220b, and the migration key 310. Here, the counter value 604b and the address 302b are combined and the encryption function 606 encrypts the combined data using the migration key 310. The output of this operation is the OTP 608b, which is combined with the data 304b (e.g., the unencrypted data or plaintext) of the memory block 220b via the XOR operation 610. The XOR operation 610 outputs encrypted data 612b (e.g., ciphertext), which is hashed by the hashing function 614 to produce the hash 602b. In various implementations, this process is repeated to generate additional hashes for additional memory blocks 220.

In one or more implementations, the described techniques of example 600 are leveraged to generate the first hashes 226 for each memory block 220 of each memory page 218 of the VM allocated memory 216 during the first migration iteration 224. In these implementations, the hashes 602a, 602b are the first hashes 226, the counter values 604a, 604b are the counter values 308 (e.g., initialized to zero), and the encrypted data 612a, 612b is the encrypted data 312. Additionally or alternatively, the described techniques of example 600 are leveraged to generate the second hashes 234 for each memory block 220 of each dirty memory page 232 during the identification phase 402 of a subsequent migration iteration. Here, the hashes 602a, 602b are the second hashes 234 and the counter values 604a, 604b are the counter values as stored in memory 210 (and/or updated) during the previous migration iteration. Additionally or alternatively, the described techniques of example 600 are leveraged to generate the updated hashes 410 for each dirty memory block 230 of each dirty memory page 232 during the transfer phase 404 of the subsequent migration iteration. Here, the memory blocks 220a, 220b are the dirty memory blocks 230, the hashes 602a, 602b are the updated hashes 410, the counter values 604a, 604b are the updated counter values 406, and the encrypted data 612a, 612b is the encrypted data 408.

FIG. 7 depicts an example 700 of generating combined hashes of memory blocks in accordance with one or more implementations. In the example 700, a combined hash 702 is generated in accordance with the modified AES-GCM protocol. Further, the memory blocks 220 are larger than the memory chunks on which the authenticated encryption is performed in the example 700. For example, the memory blocks 220 of the example 700 are two hundred fifty-six bits, and the modified AES-GCM protocol is configured to perform authenticated encryption on one hundred twenty-eight bit memory chunks. In other words, each memory block 220 of FIG. 7 includes two memory chunks 704a, 704b on which the modified AES-GCM protocol performs authenticated encryption.

Here, the address 302a of the first memory chunk 704a, a counter value 706 of the memory block 220, and the migration key 310 are provided as input to the encryption function 606. The counter value 706 and the address 302a are combined and the encryption function 606 encrypts the combined data using the migration key 310. The output of this operation is the OTP 708a, which is combined with the data 304a (e.g., the unencrypted data or plaintext) of the first memory chunk 704a via the XOR operation 610. The XOR operation 610 outputs encrypted data 710a (e.g., ciphertext) of the first memory chunk 704a, which is hashed by the hashing function 614 to produce an intermediate hash 712.

Similar operations are performed for the second memory chunk 704b. Here, the address 302b of the second memory chunk 704b, the counter value 706 of the memory block 220, and the migration key 310 are provided as input to the encryption function 606. Furthermore, the counter value 706 and the address 302b are combined, and the encryption function 606 encrypts the combined data using the migration key 310. The output of this operation is the OTP 708b, which is combined with the data 304b (e.g., the unencrypted data or plaintext) of the second memory chunk 704b via the XOR operation 610. The XOR operation 610 outputs encrypted data 710b (e.g., ciphertext) of the second memory chunk 704b, which is combined with the intermediate hash of the first memory chunk 704a via the XOR operation 610. The output of this operation is hashed by the hashing function 614 to generate the combined hash 702 for the memory block 220.

In various implementations, this process is repeated to generate additional combined hashes 702 for additional memory blocks 220. Moreover, in accordance with the described techniques of example 700, different memory blocks 220 are assigned to different counter values 706, but the same counter value 706 is used to generate the encrypted data 710a, 710b for different memory chunks 704a, 704b within a common memory block 220. Furthermore, the encrypted data of a memory block 220 is the encrypted data 710a, 710b of multiple memory chunks 704a, 704b concatenated together.

While the example 700 is depicted and described in the context of a memory block 220 including two memory chunks 704a, 704b, it is to be appreciated that similar operations are performable to generate combined hashes 702 for memory blocks 220 having three or more memory chunks in variations. In the following example, a combined hash 702 is generated for a memory block 220 including four memory chunks. Initially, a first intermediate hash 712 is generated for a first memory chunk. Next, the first intermediate hash 712 is combined via the XOR operation 610 with the encrypted data of a second memory chunk and hashed by the hashing function 614 to produce a second intermediate hash 712. Further, the second intermediate hash 712 is combined via the XOR operation 610 with the encrypted data of a third memory chunk and hashed by the hashing function 614 to produce a third intermediate hash 712. Finally, the third intermediate hash 712 is combined via the XOR operation 610 with the encrypted data of a fourth memory chunk and hashed by the hashing function 614 to produce the combined hash 702.

Thus, the described techniques are employable to generate and store hashes of memory blocks 220 of a variety of sizes. The size of the memory blocks 220 is a design choice for the system 200 that involves a tradeoff of network bandwidth consumption and memory bandwidth consumption. For example, dirty memory blocks 230 trigger communication of encrypted data that is equivalent in size to the size of the memory blocks 230. Thus, smaller memory blocks 220 reduce network bandwidth consumption for the system 200 relative to larger memory blocks 220. However, the hashes generated for the memory blocks 220 are consistent (e.g., one hundred twenty-eight bits) regardless of the size of the memory blocks 220 due to the combination of the intermediate hashes. Since the hashes of the memory blocks 220 are stored in the memory 210 of the source server 202, larger memory blocks 220 reduce consumption of the memory 210 relative to smaller memory blocks 220.

In one or more implementations, the described techniques of example 700 are leveraged to generate the first hashes 226 for each memory block 220 of each memory page 218 of the VM allocated memory 216 during the first migration iteration 224. In these implementations, the combined hashes 702 are the first hashes 226, the counter values 706 are the counter values 308 (e.g., initialized to zero), and the encrypted data 710a, 710b is the encrypted data 312. Additionally or alternatively, the described techniques of example 700 are leveraged to generate the second hashes 234 for each memory block 220 of each dirty memory page 232 during the identification phase 402 of a subsequent migration iteration. Here, the combined hashes 702 are the second hashes 234, and the counter values 706 are the counter values as stored in memory 210 (and/or updated) during the previous migration iteration. Additionally or alternatively, the described techniques of example 700 are leveraged to generate the updated hashes 410 for each dirty memory block 230 of each dirty memory page 232 during the transfer phase 404 of the subsequent migration iteration. Here, the memory blocks 220 of the example 700 are the dirty memory blocks 230, the combined hashes 702 are the updated hashes 410, the counter values 706 are the updated counter values 406, and the encrypted data 710a, 710b is the encrypted data 408.

The modified AES-GCM protocol described above with reference to FIGS. 6 and 7 differs from conventional AES-GCM in a variety of ways. Firstly, the modified AES-GCM protocol provides, as input to the encryption function 606, counter values specific to each memory block 220 that are incremented when a respective memory block 220 is modified (e.g., dirtied) over consecutive migration iterations. Secondly, the modified AES-GCM protocol generates the OTP(s) of a memory block based on the memory address(es) 302 of the memory block 220. Thirdly, the hashes (e.g., the hashes 602a, 602b or the combined hashes 702) of the memory blocks 220 are not based on hashes of previous memory blocks 220 in the sequence.

Notably, the encryption/decryption logic 504 of the destination server 204 decrypts the encrypted data 408 of the dirty memory blocks 230 using the modified AES-GCM protocol. As part of the decryption process, the encryption/decryption logic 504 leverages the encryption function 606 to generate OTPs for the dirty memory blocks 220. In one or more implementations, the destination server 204 is configured to pre-compute OTPs for the dirty memory blocks 230 before receiving the dirty memory blocks 230. For example, in response to identifying the dirty memory blocks 230 during the identification phase 402, the source server 202 generates, encrypts, and communicates the dirty bit vector 414 to the destination server 204. The source server 202 does so before having completed generating the encrypted data 408 for the dirty memory blocks 230. The destination server 204 decrypts the dirty bit vector 414 to identify the dirty memory blocks 230 and the addresses 302 thereof. Furthermore, the destination server 204 increments the counter values of the dirty memory blocks 230 stored in the memory 212. In addition, the destination server 204 computes the OTPs of the dirty memory blocks 230 for the purpose of decrypting the encrypted data 408 before receiving the encrypted data 408, which reduces migration iteration latency.

Notably, the hashing function 614 of the modified AES-GCM protocol outputs hashes that are one hundred twenty-eight bits. In one or more implementations, the modified AES-GCM algorithm is configured to perform a reduction operation on the output of the hashing function 614 to reduce the hashes to sixty-four bits. To do so, the modified AES-GCM protocol combines the first sixty-four bits of the hash and the second sixty-four bits of the hash via an XOR operation. As a result, the hashes of the memory blocks 220 are sixty-four bits rather than one hundred twenty-eight bits. Since the hashes of the memory blocks 220 are stored in the memory 210 of the source server 202, reducing the size of the hashes in the manner described further reduces memory consumption at the source server 202.

While highly unlikely, it is possible that a same hash is generated for a memory block 220 during consecutive migration iterations although the data contained in the memory block 220 is dirty. This phenomenon is known as hash collision, and causes the migration logic 124 to refrain from transferring a dirty memory block 230, resulting in data corruption. To prevent hash collision, the migration logic 124 is configured to regenerate the hashes for the VM allocated memory 216 located on the source server 202 and the destination server 204 after the final migration iteration. In particular, the migration logic 124 generates the hashes using the traditional AES-GCM algorithm based on a randomly generated initialized vector (e.g., rather than the addresses 302) and a different key. Furthermore, the migration logic 124 compares source hashes generated on the data of the VM allocated memory 216 that is stored on the source server 202 to destination hashes generated on the data of the VM allocated memory 216 that is stored on the destination server 204. If the source hashes and the destination hashes match, the migration logic 124 confirms a lack of hash collision and completes the live migration process. Alternatively, the migration logic 124 detects hash collision and restarts the live migration process.

In another example, the migration logic 124 prevents hash collision by storing duplicates of the VM allocated memory 216 in memory 212 of the destination server 204 and secondary storage (e.g., storage 112) of the source server 202. In this example, the VM allocated memory 216 is concurrently transferred to the destination server 204 and copied to secondary storage during the first migration iteration. Whenever data is modified in main memory of the source server 202 during the live migration process, the corresponding data is also modified in secondary storage of the source server 202. After the final migration iteration, the migration logic 124 compares the VM allocated memory 216 in the secondary storage of the source server 202 to the VM allocated memory 216 present in the memory 212 of the destination server 204. If the migration logic 124 refrained from transferring a dirty memory page 232 due to hash collision, the different instances of the VM allocated memory 216 will not match. Accordingly, if the different instances of the VM allocated memory 216 present in the secondary storage of the source server 202 and the destination server 204 match, the migration logic 124 confirms a lack of hash collision and completes the live migration process. Alternatively, the migration logic 124 detects hash collision and restarts the live migration process.

While traditional AES-GCM leverages counter values that are sixty-four bits in length for encryption, the described techniques use smaller counter values in various implementations. In the following discussion, consider an example in which the counter values are six bits. Here, the migration logic 124 is configured to perform less than a threshold number of migration iterations during the live migration process of the virtual machine 214. Furthermore, the threshold number is configured as the maximum number conveyable by the counter values, e.g., the threshold number is sixty-four for six bit counter values. In this way, even if a memory block 220 is modified before every subsequent migration iteration, the counter value of the memory block can still convey the number of times that the memory block 220 was modified over consecutive migration iterations. In practice, it is highly unlikely that more than sixty-four migration iterations are performed before the virtual machine 214 is transferred to the destination server 204 during the blackout phase, hence the design choice of six bits for the counter values. Since the counter values are stored in the memory 210 of the source server 202 and the memory 212 of the destination server 204, reducing the size of the counter values reduces memory consumption at both the source server 202 and the destination server 204. It is to be appreciated that the counter values range from six bits to sixty-four bits in variations.

As mentioned above, the migration logic 124 is configured to generate hashes of unencrypted data of the memory blocks 220 in various scenarios. During the first migration iteration 224, the migration logic 124 generates and stores (e.g., in memory 210) first hashes 226 of the unencrypted (e.g., plaintext) data of each memory block 220 of each memory page 218. During the identification phase 402 of a subsequent migration iteration, the migration logic 124 generates second hashes 234 of the unencrypted (e.g., plaintext) data of each memory block 220 in each dirty memory page 232, and compares the first hashes 226 to the second hashes 234 to identify the dirty memory blocks 230. During the transfer phase 404 of the subsequent migration iteration, the migration logic 124 encrypts the data of the dirty memory blocks 230 using an authenticated encryption function (e.g., traditional AES-GCM) for transfer to the destination server 204.

In another alternative implementation, the migration logic 124 leverages traditional AES-GCM to transfer less than the entirety of a dirty memory page 232 during live migration of the virtual machine 214. In accordance with the traditional AES-GCM algorithm, each subsequent memory block 220 is dependent on the data in previous memory blocks 220, as previously discussed. Thus, when a dirty memory block 230 of a dirty memory page 232 is identified based on the comparison of the first hashes 226 and the second hashes 234, the hashes of all subsequent memory blocks 220 in the dirty memory page 232 are modified. Accordingly, in this alternative implementation, the migration logic 124 transfers the first identified dirty memory block 230 and all subsequent memory blocks 220 of the dirty memory page 232. As previously mentioned, the traditional AES-GCM algorithm uses counter values of the memory blocks 220 that are incremented from a previous memory block 220 in the sequence. As such, in this alternative implementation, the source server 202 and the destination server 204 do not store the counter values in memory since the counter values are computable during the authentication encryption process.

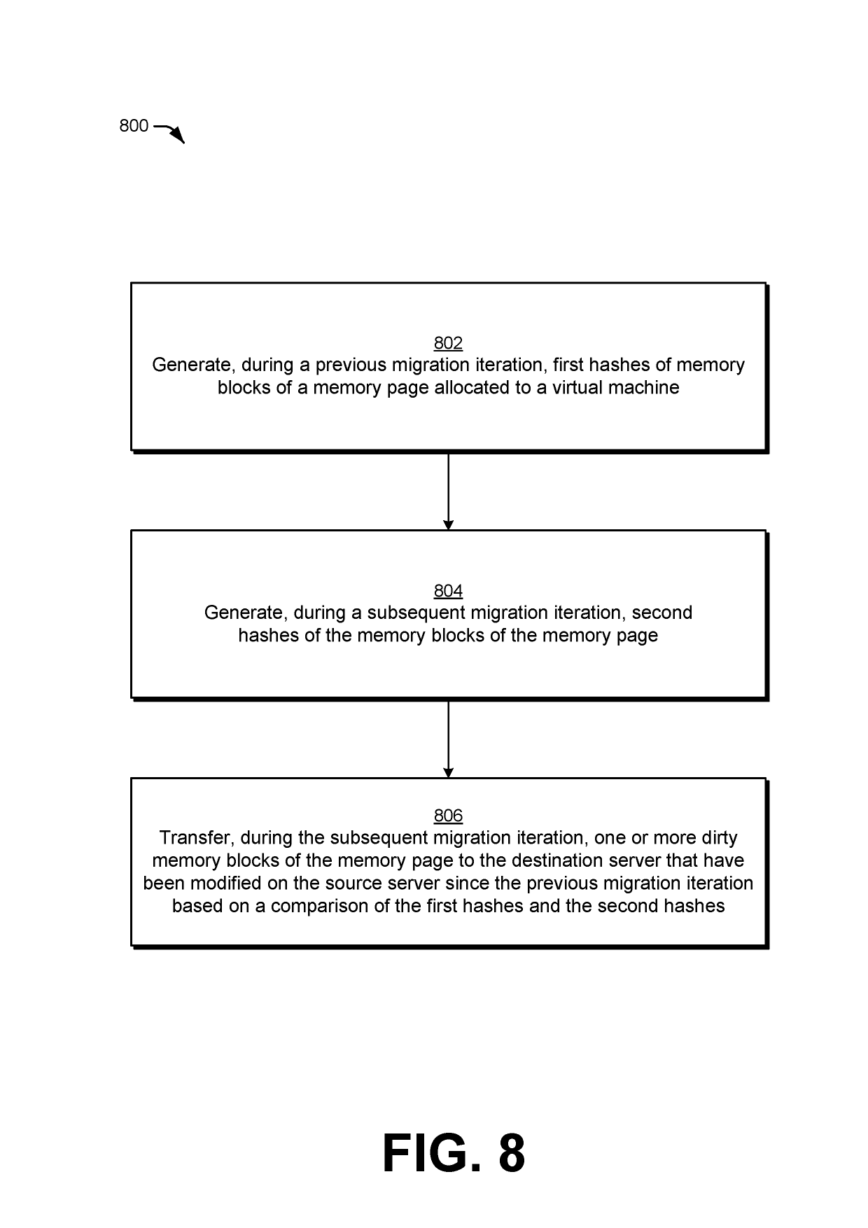

FIG. 8 depicts a procedure 800 in an example implementation of dirty data tracking for live migration of virtual machines. In the procedure 800, first hashes of memory blocks of a memory page are generated during a previous migration iteration, and the memory page is allocated to a virtual machine (block 802). For example, the VM allocated memory 216 includes a memory page 218. Moreover, the encryption/decryption logic 306 encrypts the memory blocks 220 of a memory page 218 using a migration key 310 and an authenticated encryption function (e.g., the modified AES-GCM protocol) during the first migration iteration 224. As part of this, the encryption/decryption logic 306 generates encrypted data 312 and first hashes 226 of the memory blocks 220. The migration logic 124 stores the first hashes 226 in memory 210 of the source server 202, and transfers the encrypted data 312 of the memory page 218 to the destination server 204. The destination server 204 is configured to decrypt the encrypted data 312 using the modified AES-GCM protocol and the migration key 310, re-encrypt the data of the memory blocks 220 using a private key of the destination server 204, and store the re-encrypted data in the memory 212 of the destination server 204.

Second hashes of the memory blocks of the memory page are generated during a subsequent migration iteration (block 804). For instance, the migration logic 124 identifies the memory page 218 as a dirty memory page 232 using the page tracking data structure. Moreover, the encryption/decryption logic 306 encrypts the memory blocks 220 of the dirty memory page 232 using the migration key 310 and the authenticated encryption function (e.g.., the modified AES-GCM protocol) during the identification phase 402 of the subsequent migration iteration. As part of this, the encryption/decryption logic 306 generates second hashes 234 of the memory blocks 220.

One or more dirty memory blocks of the memory page that have been modified on the source server since the previous migration iteration are transferred to the destination server during the subsequent migration iteration based on a comparison of the first hashes and the second hashes (block 806). By way of example, the migration logic 124 compares the first hashes 226 stored in the memory 210 to the second hashes 234 during the identification phase 402 of the subsequent migration iteration. If the first hash 226 of a memory block 220 differs from the second hash 234 of the memory block 220, the migration logic 124 identifies the memory block 220 as a dirty memory block 230. Once the dirty memory blocks 230 are identified, the encryption/decryption logic 306 re-encrypts the data of the dirty memory blocks 230 using the migration key 310 and the authenticated encryption function (e.g., the modified AES-GCM protocol) during the transfer phase 404 of the subsequent migration iteration. In doing so, the encryption/decryption logic 306 generates encrypted data 408 of the dirty memory blocks 230 and updated hashes 410 of the dirty memory blocks 230.

The source server 202 stores the updated hashes 410 in the memory 210 of the source server 202 to be compared with hashes generated for the memory page 218 during a later migration iteration. Moreover, the source server 202 transfers the encrypted data 408 of the dirty memory blocks 230 to the destination server 204 during the transfer phase 404. Notably, the source server 202 refrains from transferring data of the clean memory blocks 220 of the dirty memory page 232. The destination server 204 receives the encrypted data 408 of the dirty memory blocks 230, decrypts the encrypted data 408 using the modified AES-GCM protocol and the migration key 310, re-encrypts the data using the private key of the destination server 204, and stores the re-encrypted data in memory 212 of the destination server 204. In particular, the destination server 204 replaces the data of the dirty memory blocks 230 transferred during a previous migration iteration with the data of the dirty memory blocks 230 transferred during the subsequent migration iteration.

In one or more implementations, the memory blocks 220 correspond in size with the memory chunks on which the authenticated encryption is performed, and the first hashes 226, the second hashes 234, and the updated hashes 410 are generated in accordance with example 600 of FIG. 6. For example, the hashes 226, 234, 410 are generated as the hashes 602a, 602b. Additionally or alternatively, the memory blocks 220 include multiple memory chunks on which the authenticated encryption is performed, and the first hashes 226, the second hashes 234, and the updated hashes 410 are generated in accordance with example 700 of FIG. 7. For instance, the hashes 226, 234, 410 are generated as the combined hashes 702.

What is claimed is:

1. A system comprising:
a destination server; and
a source server configured to migrate a virtual machine running on the source server to the destination server over multiple migration iterations by performing operations including:
generating, during a first migration iteration of the multiple migration iterations, first hashes of memory blocks of a memory page allocated to the virtual machine;
generating, during a second migration iteration of the multiple migration iterations, second hashes of the memory blocks of the memory page; and
transferring, during the second migration iteration, one or more dirty memory blocks of the memory page to the destination server that have been modified on the source server since the first migration iteration based on a comparison of the first hashes and the second hashes.

2. The system of claim 1, wherein the one or more dirty memory blocks are each associated with a respective first hash of the first hashes and a respective second hash of the second hashes, and wherein the respective first hash and the respective second hash are different.

3. The system of claim 1, the operations further including generating, during the multiple migration iterations, encrypted data of the memory blocks.

4. The system of claim 3, wherein generating the first hashes includes generating the first hashes of the encrypted data of the memory blocks during the first migration iteration, and generating the second hashes includes generating the second hashes of the encrypted data of the memory blocks during the second migration iteration, and transferring the one or more dirty memory blocks includes transferring the encrypted data of the one or more dirty memory blocks.

5. The system of claim 3, wherein generating the encrypted data includes providing memory addresses of the memory blocks as input to an authenticated encryption function.

6. The system of claim 3, wherein generating the encrypted data includes providing counter values of the memory blocks as input to an authenticated encryption function, a counter value of a respective memory block representing a number of times the respective memory block has been modified on the source server over consecutive migration iterations of the multiple migration iterations.

7. The system of claim 6, the operations further including:
storing, during the first migration iteration, the first hashes and the counter values in memory of the source server;
generating, during the second migration iteration, the second hashes using the counter values stored in the memory; and
detecting, during the second migration iteration, the one or more dirty memory blocks based on the comparison of the first hashes stored in the memory to the second hashes.

8. The system of claim 7, the operations further including:
incrementing, during the second migration iteration, one or more of the counter values of the one or more dirty memory blocks responsive to detecting the one or more dirty memory blocks;
regenerating, during the second migration iteration, one or more hashes of the one or more dirty memory blocks using the one or more incremented counter values;
storing, during the second migration iteration, the one or more incremented counter values in the memory; and
replacing, during the second migration iteration, one or more of the first hashes of the one or more dirty memory blocks with the one or more regenerated hashes in the memory.

9. The system of claim 8, the operations further including:
generating, during the second migration iteration, an authentication tag by combining the one or more regenerated hashes of the one or more dirty memory blocks using a secure hash combination function; and
communicating, during the second migration iteration, the authentication tag to the destination server.

10. The system of claim 1, the operations further including:
generating, during the second migration iteration, a vector that identifies the one or more dirty memory blocks; and
communicating, during the second migration iteration, the vector to the destination server.

11. The system of claim 1, wherein generating the first hashes and the second hashes includes generating, during the multiple migration iterations, combined hashes of the memory blocks, a combined hash of a respective memory block representing a combination of additional hashes of multiple memory chunks within the respective memory block.

12. The system of claim 11, wherein the first hashes are the combined hashes of the memory blocks generated during the first migration iteration, and the second hashes are the combined hashes of the memory blocks generated during the second migration iteration.

13. A system comprising:
a source server running a virtual machine; and
a destination server to receive a memory page of the virtual machine partitioned into memory blocks as part of a migration process to migrate the virtual machine to the destination server by performing operations including:
receiving, during a second migration iteration, one or more dirty memory blocks of the memory page that have been modified on the source server since a first migration iteration, the one or more dirty memory blocks detected based on a comparison of first hashes of the memory blocks generated during the first migration iteration to second hashes of the memory blocks generated during the second migration iteration.

14. The system of claim 13, the operations further including storing, in memory of the destination server, counter values of the memory blocks, a counter value of a respective memory block representing a number of times the respective memory block has been modified over consecutive migration iterations.

15. The system of claim 14, wherein receiving the one or more dirty memory blocks includes receiving encrypted data of the one or more dirty memory blocks having been encrypted using an authenticated encryption function, the operations further including:
incrementing one or more of the counter values associated with the one or more dirty memory blocks;
receiving one or more memory addresses of the one or more dirty memory blocks and an authentication tag representing a first combination of one or more hashes of the one or more dirty memory blocks;
generating, using the authenticated encryption function, a validation tag based on the encrypted data, the one or more memory addresses, and the one or more incremented counter values; and
accepting the one or more dirty memory blocks into the memory based on the validation tag matching the authentication tag.

16. The system of claim 15, wherein incrementing the one or more counter values includes receiving a vector that identifies the one or more dirty memory blocks, and incrementing the one or more counter values based on the vector.

17. The system of claim 16, the operations further comprising decrypting the encrypted data of the one or more dirty memory blocks, in part, by computing, before receiving the one or more dirty memory blocks, one or more one-time pads for the one or more dirty memory blocks based on the vector and the one or more incremented counter values.

18. A source server configured to:
migrate a memory page of a virtual machine to a destination server by performing operations including:
generating, during a first migration iteration, a first combined hash of a memory block of the memory page by combining first hashes of multiple memory chunks within the memory block;
generating, during a second migration iteration, a second combined hash of the memory block by combining second hashes of the multiple memory chunks within the memory block; and
transferring, during the second migration iteration, the memory block to the destination server based on the first combined hash and the second combined hash being different.

19. The source server of claim 18, wherein the memory block is not transferred to the destination server during the second migration iteration based on the first combined hash equaling the second combined hash.

20. The source server of claim 18, the operations further comprising storing a counter value of the memory block in memory of the source server, the counter value representing a number of times the memory block has been modified on the source server over consecutive migration iterations, and wherein the first combined hash and the second combined hash are generated based on the counter value.
